(19) United States
(12) Patent Application Publication
(10) Pub. No.: US 2016/0026006 A1
(43) Pub. Date: Jan. 28, 2016

(54) Molded Lens

(71) Applicant: Vision Ease, LP, Ramsey, MN (US)

(72) Inventors: David Olund, Stanchfield, MN (US); James Kunkel, Monticello, MN (US); Richard Blacker, Lino Lakes, MN (US)

(73) Assignee: VISION EASE, LP, Ramsey, MN (US)

(21) Appl. No.: 14/809,120

(22) Filed: Jul. 24, 2015

Related U.S. Application Data
(60) Provisional application No. 62/029,363, filed on Jul. 25, 2014.

(51) Int. Cl. G02C 7/10; B29C 45/00; G02C 7/12

(52) U.S. Cl. CPC G02C 7/108; G02C 7/102; G02C 7/12; B29C 45/0003; G02C 2202/16; B29L 2011/0016

(57) ABSTRACT

A composite ophthalmic lens having a thin functional first molded portion that is fused and/or re-molded during formation of a second, transparent molded portion.

### RELATED APPLICATIONS

This application claims priority to U.S. Provisional Application Ser. No. 62/029,363 filed Jul. 25, 2015, entitled Molded Lens, which is incorporated herein by reference in its entirety.

### FIELD OF THE INVENTION

The present application relates to molded optical lenses and, more particularly, composite molded lenses formed of at least a thin functional first molded portion that is fused or re-molded to a second molded portion.

### BACKGROUND OF THE INVENTION

Producing colored or tinted optical lenses poses several difficulties. For example, if such lenses are to be produced from a polymeric material, it is desirable to simply mix a dye or coloration agent into the polymeric material and then use the colored, polymeric material to form the desired lens by a process such as injection molding or casting. However, in the case of tinted, ophthalmic lenses that provide a vision correction feature, such lenses have a varying thickness due to the corrective nature of the lens. Hence, the thinner portions of the lens will be formed of less of the colored, polymeric material and will thereby have less coloration than thicker portions of the same lens. Lenses exhibiting such color variations are typically not acceptable in the market place. Another challenge in the production of tinted lenses is the fact that the dye or coloration agent is often significantly expensive relative to the bulk polymeric material of the lens.

In order to address both of these issues, lens manufactures have employed manufacturing methods in which a tinted, uniform thickness, film laminate is produce and then adhered or otherwise attached to the bulk lens material or resin that forms the remainder of the resulting lens. While this technique has allowed for more uniformly tinted lenses and has help reduce the amount of dye required for a desired degree of tinting, the formation of the film laminates and the incorporation of the laminates into lenses introduces another array of process challenges that counter the economic advantages realized by the reduction of the quantity of dye used.

What is needed in the art is a more cost effective and process friendly alternative to employing film laminates for the production of tinted polymeric lenses.

### OBJECTS AND SUMMARY OF THE INVENTION

One objective of the present invention is to provide a more cost effective and process friendly alternative to employing film laminates for the production of tinted polymeric lenses. This objective is, in part, achieved by first forming a thin tinted or functional molded lens and then re-molding the thin functional lens to a transparent bulk lens resin and, in certain application, to a functional laminate. Accordingly, the resulting lens has a thin, uniformly colored or tinted layer on, for example a front convex surface of the lens, and a non-tinted, transparent layer on, for example, a back concave surface of the lens. The back non-tinted, transparent layer may then be ground and/or polished to achieve the desired optical power or powers in the resulting lens.

### BRIEF DESCRIPTION OF THE DRAWINGS

These and other aspects, features and advantages of which embodiments of the invention are capable of will be apparent and elucidated from the following description of embodiments of the present invention, reference being made to the accompanying drawings, in which

FIG. 1 is a perspective view of a thin functional lens according to one embodiment of the present invention.

FIG. 2 is a perspective view of a pair of composite ophthalmic lenses according to one embodiment of the present invention.

FIG. 3 is a cross-sectional view of a composite ophthalmic lens according to one embodiment of the present invention.

### DESCRIPTION OF EMBODIMENTS

Specific embodiments of the invention will now be described with reference to the accompanying drawings. This invention may, however, be embodied in many different forms and should not be construed as limited to the embodiments set forth herein; rather, these embodiments are provided so that this disclosure will be thorough and complete, and will fully convey the scope of the invention to those skilled in the art. The terminology used in the detailed description of the embodiments illustrated in the accompanying drawings is not intended to be limiting of the invention. In the drawings, like numbers refer to like elements.

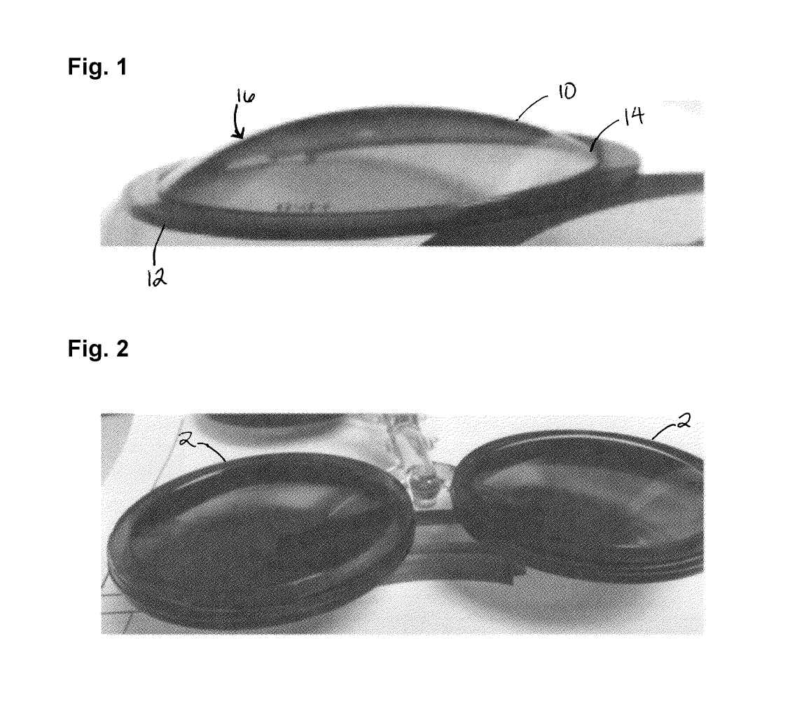

Generally speaking, the present invention provides a cost effective and process friendly alternative to employing film laminates for the production of tinted lenses. With reference to FIGS. 1-3, these objectives are, in part, achieved by first injection molding a relatively thin tinted lens, referred to herein as a thin functional lens 10. A transparent bulk lens material or resin 20 is then molded on to a front surface 16 and/or a back surface 18 of the thin functional lens 10 to thereby form a finished or semi-finished ophthalmic lens 2.

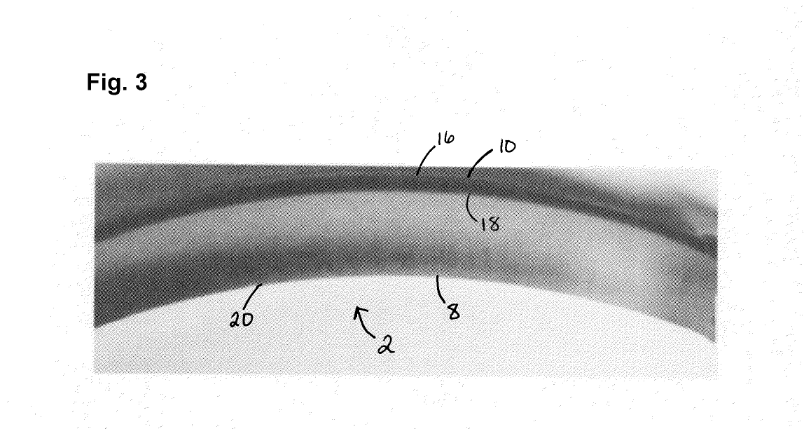

As shown in FIG. 3, the resulting finished or semi-finished ophthalmic lens 2 has a thin, uniform layer of colored lens material fused to the layer of transparent bulk lens material 20. In the case of a semi-finished lens 2, a back surface 8 of the semi-finished lens 2, formed by the transparent bulk lens material or resin 20, may then be ground and/or polished to provide one or more desired focal powers without altering the uniform coloration provided in the lens 2 by the thin functional lens 10.

In certain embodiments, the thin functional lens 10 is formed of a single layer of material into which one or more functional materials such as a dye or other coloration agent has been mixed. Colorants or dyes may be either permanent or dynamic. Permanent colorants include traditional dyes and pigments, including metameric and magnetic pigments, which can change color or alignment under different lighting or magnetic environments. Permanent colorants are generally soluble dyes but may also be pigments having sufficiently small particle size, for example, less than 10 nanometers. Such permanent colorants may alternatively be incorporated within the continuous phase with consideration being taken to the particle size requirements and controlling hazing.

Dynamic colorants may, for example, be any suitable photochromic compounds. For example, organic compounds that, when molecularly dispersed, as in a solution state, are activated (darken) when exposed to a certain light energy (e.g., outdoor sunlight), and bleach to clear when the light energy is removed. They can be selected from benzopyrans, naphthopyrans, spirobenzopyrans, spironaphthopyrans, spirobenzoxzines, spironaphthoxazines, fulgides and fulgimides. Such photochromic compounds have been reported, for example, in U.S. Pat. Nos. 5,658,502, 5,702,645, 5,840,926, 6,096,246, 6,113,812, and 6,296,785; and U.S. patent application Ser. No. 10/038,350, all commonly assigned to the same assignee as the present invention and all incorporated herein by reference.

Among the photochromic compounds identified, naphthopyran derivatives exhibit good quantum efficiency for coloring, a good sensitivity and saturated optical density, an acceptable bleach or fade rate, and most importantly good fatigue behavior for use in eyewear. These compounds are available to cover the visible light spectrum from 400 nanometer to 700 nanometer. Thus, it is possible to obtain a desired blended color, such as neutral gray or brown, by mixing two or more photochromic compounds having complementary colors under an activated state.

In certain embodiments, the use of variously colored dyes in specific microenvironments which alter the color of the dyes so as to produce neutral grey colors when activated by virtue of the small a* and b* values observed in the specific microenvironments is achieved.

Suitable dyes include naphtho[2,1b]pyrans and naphtho[1,2b]pyrans represented by the following generic formula:

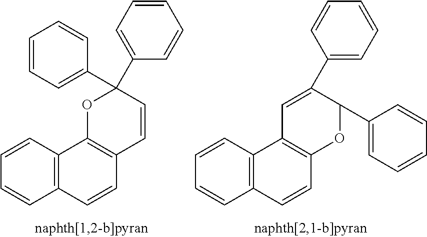 [SMILES: C1=CC(c2ccccc2)(c2ccccc2)Oc2c1ccc1ccccc21 ; C1=C(c2ccccc2)C(c2ccccc2)Oc2ccc3ccccc3c21]

In certain embodiments of the present invention, the colorants include one or more photochromic dyes and optionally, one or more permanent dyes and/or pigments. In certain embodiments, the colorants only include permanent dyes and/or pigments.

In certain embodiments of the present invention, the thin functional lens 10 may have a uniform thickness between a front surface 16 and the back surface 18 of approximately 0.5 to 2.5 millimeters. The thin functional lens 10 may, but need not necessarily be formed with a stabilizing rim or flange 12 around a perimeter 14 of the thin functional lens 10 such as the thin lens and flange disclosed in the Assignee's U.S. Provisional Application Ser. No. 62/029,355 filed Jul. 25, 2014 entitled Stabilized Thin Lens, and U.S. Non-provisional Application Ser. No. 14/809,093, filed Jul. 24, 2015, entitled Stabilized Thin Lens, both of which are hereby incorporated by reference in their entirety.

In certain embodiments of the present invention, the thin functional lens 10 is formed through, for example, an injection molding process.

The present invention is not limited by the polymeric material employed to form the thin lens 10. The substrate may comprise polycarbonate resin such as that sold by Teijin, Sabic, and Bayer, Inc. of Pittsburgh, Pa. under various tradenames. The lens substrate may also comprise other thermoplastic materials such as polyamides, polystyrenes, polysulphones, mixtures of polycarbonate and polyurethanes, polyesters, polysulfones, polystyrenes, amorphous polyolefins, and acrylics.

The material used to form the thin functional lens 10 may be the same type of material or substrate as employed for formation of the transparent bulk lens material or resin 20. Alternatively, the material used to form the thin functional lens 10 may be a different type of material or substrate as employed for formation of the transparent bulk lens material or resin 20.

In certain embodiments of the present invention, the thin functional lens 10 may be formed of a material having an index of refraction different from the index of refraction of the material forming the transparent bulk lens material or resin 20.

In certain embodiments of the present invention, the thin functional lens 10 may further employ one or more functional films, functional laminates, and/or functional coatings. The functional attributes of the films, laminates, or coatings may include, for example, anti-reflection, anti-fogging, hard coating, polarization, photochromism, and easy-cleaning. The functional films, laminates, and/or coatings may be incorporated or otherwise attached to the front surface 16; a back surface 14 of the thin functional lens 10; and/or between the front surface 16 and the back surface 14 of the thin functional lens 10.

As used therein and commonly understood in the field, the term “laminate” describes a multilayered sheet or film structure formed of separate, independently formed sheets or films bonded, adhered, fused or otherwise attached to one another. The term “functional laminate” describes a laminate employing one or more functional sheets or layers having, for example, any of the above listed functional attributes. Such functional laminates are further described in the Assignee's U.S. Pat. Nos. 8,367,211; 8,298,671; 8,128,224; 8,002,935; 7,858,001; 7,377,639; 7,077,985; 7,036,932; 6,761,452; and 5,757,459; and U.S. application Ser. Nos. 13/645,696; 13/741,290; 13/563,236; 13, 737,871; and 13/737,871, and 14/751,043, all of which are herein incorporated by reference in their entireties.

In certain embodiments of the present invention, in addition to or in place of the dye or other coloration agent, the thin functional lens 10 may incorporate other materials that impart one or more functional characteristics. For example, the thin functional lens 10 may be employed to manipulate properties of the lens 2, such as the abbe number or value and the index of refraction or to introduce new or different materials into a lens 2 or to provide for a matched coating index program.

In certain embodiments of the present invention, the front surface 16 of the thin functional lens 10 has an initial curvature that is equal to the target base power or curvature of the lens 2 that incorporates the same thin functional lens 10. In certain embodiments, the front surface 16 of the thin functional lens 10 has an initial curvature that varies by approximately minus 1 to minus 2 diopter from the target base power or curvature of the lens 2 that incorporates the same thin functional lens 10. The finished or semi-finished lens 2 may ultimately be a plano; a single focus; a single or double sided segmented multi-focus, or a single or double sided progressive multi-focus lens.

In certain embodiments of the present invention, the front surface 16 of the thin functional lens 10 has multiple focal powers and may be employed to form a segmented or progressive multi-focal lens 2.

The present invention is not limited by the material employed to form the transparent bulk lens material or resin 20. The material may be a thermoset material or a thermoplastic material as disclosed above with respect to the materials employed for formation of the thin functional lens 10.

In practice, after injection molding of the thin functional lens 10, the transparent bulk lens material or resin 20 is, for example, injection molded onto the front side 16 of the thin functional lens 10; injection molded onto the backside 18 of the thin functional lens 10; or injection molded onto the front side 16 and the backside 18 of the thin functional lens 10.

In certain embodiments of the present invention, the lens 2 may further employ one or more functional films or functional laminates inserted between the thin functional lens 10 and the transparent bulk lens material or resin 20. The functional attributes of the film and/or laminate may include, for example, anti-reflection, anti-fogging, hard coating, polarization, photochromism, and easy-cleaning. The functional film or laminate may be independent of the thin functional lens 10 and may be incorporated between the thin functional lens 10 and the transparent bulk lens material or resin 20 during the injection molding process.

In one embodiment of the present invention, the lens 2 is formed according to the following method. First, a dye or tinting agent is incorporated into the resin intended for formation of the thin functional lens 10. The colored resin is then injected into a mold cavity of an injection molding set-up. The colored resin is cooled and the resulting thin functional lens 10 is removed from the injection molding set-up. At this stage, the thin functional lens 10 may either be stored for later use or may be immediately transferred and used to form a lens 2, as described below.

The thin functional lens 10 is next placed into an injection mold cavity for formation of the lens 2. The thin functional lens 10 is placed into the injection mold set-up with the front convex side 16 of the thin functional lens 10 against a concave side of a lens mold. The mold cavity is closed and the transparent bulk lens material or resin 20 is injected into the mold cavity against the back, concave side 14 of the thin functional lens 10. The transparent bulk lens material or resin 20 fuses to the back, concave side 14 of the thin functional lens 10; the mold cavity is cooled; and the resulting lens 2 is removed from the injection molding set-up.

In an alternative embodiment of the present invention, the lens 2 is formed according to the following method. First, a dye or tinting agent is incorporated into the resin intended for formation of the thin functional lens 10. The colored resin is then injected into a mold cavity of an injection molding set-up. The colored resin is cooled and the mold cavity is opened, i.e. the two molds forming the mold cavity are separated. The convex mold half of the mold cavity that formed the back, concave side 14 of the thin functional lens 10 is then replaced or exchanged with a mold half that will form the desired shape on the back side 8 of the lens 2, opposite the convex side of lens 2.

Of significance, in the above-described alternative method is that the thin functional lens 10 is not removed from the concave mold half of the injection molding set-up prior to formation of the lens 2. Rather, in order to form the lens 2, only the original convex mold half is exchanged prior to formation of the lens 2.

The present invention advantageously allows for the uniform tinting of a lens without the necessity of producing and incorporating a relatively costly film laminate into the resulting lens. The re-moldable, thin functional lens 10 of the present invention is a more cost efficient manner of producing the desired thin, uniformly colored dye layer of the lens while using existing molds and manufacturing techniques.

### EXAMPLE

A tinted, semi-finished, single vision lens according to the present invention was formed as described below. With reference to FIG. 1, a thin functional lens 10 was formed by injection molding of a tinted molten polycarbonate. The thin functional lens 10 had a uniform thickness of 1.3 millimeters.

With reference to FIGS. 1-3, the thin functional lens was then placed within a mold cavity with the convex front side 16 of the thin functional lens 10 against the concave half of the mold cavity. Non-tinted, molten polycarbonate was then injected into the cavity on the concave back side 14 of the thin functional lens 10. The non-tinted, polycarbonate fused to the concave back side 18 of the thin functional lens 10 during the molding process, in part, due to heat and pressure applied within the mold. The resulting composite lens 2 was cooled and then removed from the mold cavity.

The resulting lens 2 had a polycarbonate structure with a defined tinted region and a defined non-tinted region. The resulting lens 2 showed little or no intermixing of the dye from the thin functional lens 10 with the non-tinted polycarbonate portion of the resulting lens 2.

Although the invention has been described in terms of particular embodiments and applications, one of ordinary skill in the art, in light of this teaching, can generate additional embodiments and modifications without departing from the spirit of or exceeding the scope of the claimed invention. Accordingly, it is to be understood that the drawings and descriptions herein are proffered by way of example to facilitate comprehension of the invention and should not be construed to limit the scope thereof.

What is claimed is:

1. A composite ophthalmic lens comprising:
a functional laminate or film;
a tinted layer of material molded to a desired shape;
a non-tinted layer of material molded to the tinted layer of material and the functional laminate.

2. The composite ophthalmic lens of claim 1 wherein the tinted layer of material is formed by injection molding.

3. The composite ophthalmic lens of claim 1 wherein the tinted layer of material comprises a permanent color dispersed uniformly throughout the tinted layer of material.

4. The composite ophthalmic lens of claim 1 wherein the desired shape of the tinted layer of material comprises a base curve.

5. The composite ophthalmic lens of claim 1 wherein the tinted layer of material has a uniform thickness.

6. The composite ophthalmic lens of claim 1 wherein the tinted layer of material has a thickness of approximately 0.5 to 2.5 millimeters.

7. The composite ophthalmic lens of claim 1 wherein the non-tinted layer of material is injection molded directly onto a concave surface of the tinted layer of material.

8. The composite ophthalmic lens of claim 1 wherein the functional laminate comprises a functional attribute selected from the group consisting of: anti-reflection, anti-fogging, hard coating, polarization, photochromism, and easy-cleaning.

9. A composite ophthalmic lens comprising:
a non-tinted layer of material molded to a side of a molded tinted layer of material having a substantially uniform thickness;
a functional laminate molded to a side of the non-tinted layer of material;
the non-tinted layer of material and the tinted layer of material formed of substantially the same type of polymeric resin.

10. The composite ophthalmic lens of claim 9 wherein the composite ophthalmic lens is formed by injection molding.

11. The composite ophthalmic lens of claim 9 wherein the functional laminate comprises a functional attribute selected from the group consisting of: anti-reflection, anti-fogging, hard coating, polarization, photochromism, and easy-cleaning.

12. The composite ophthalmic lens of claim 9 wherein the molded tinted layer of material has a base curve.

13. The composite ophthalmic lens of claim 9 wherein the molded tinted layer of material has a thickness of approximately 0.5 to 2.5 millimeters.

14. A method for forming a composite ophthalmic lens comprising:
molding a tinted resin in to a thin functional lens having a base curve;
molding a non-tinted resin to a side of the thin functional lens; and
molding a functional laminate to the thin functional lens.

15. The method of claim 14 wherein the step of molding a tinted resin in to a thin functional lens having a base curve comprises injection molding the tinted resin in to a thin functional lens.

16. The method of claim 14 wherein the step of molding a tinted resin in to a thin functional lens having a base curve comprises molding the tinted resin in to a uniform thickness.

17. The method of claim 14 wherein the step of molding a tinted resin in to a thin functional lens having a base curve comprises molding the tinted resin in to a thickness of approximately 0.5 to 2.5 millimeters.

18. The method of claim 14 wherein the step of molding a non-tinted resin to a side of the thin functional lens comprises injection molding the non-tinted resin directly to a side of the thin functional lens.

19. The method of claim 14 wherein the step of molding a non-tinted resin to a side of the thin functional lens comprises molding the non-tinted resin directly to a concave side of the thin functional lens.

20. The method of claim 14 wherein the step of molding a functional laminate to the thin functional lens comprises molding a functional laminate comprising a functional attribute selected from the group consisting of: anti-reflection, anti-fogging, hard coating, polarization, photochromism, and easy-cleaning.
